(19) United States
(12) Patent Application Publication
(10) Pub. No.: US 2025/0284735 A1
(43) Pub. Date: Sep. 11, 2025

(54) SEARCHING USING A WEARABLE COMPUTING DEVICE

(71) Applicant: GOOGLE LLC, Mountain View, CA (US)

(72) Inventors: Chung Chun Wan, San Jose, CA (US); Shahram Izadi, Tiburon, CA (US)

(21) Appl. No.: 19/076,562

(22) Filed: Mar. 11, 2025

Related U.S. Application Data
(60) Provisional application No. 63/563,936, filed on Mar. 11, 2024.

(51) Int. Cl. G06F 16/538; G06F 16/583; G06V 40/10

(52) U.S. Cl. CPC G06F 16/538; G06F 16/583; G06V 40/11

(57) ABSTRACT

According to at least one implementation, a method includes capturing an image and determining the image includes a gesture. The method further includes, in response to determining the image includes the gesture, generating a query from at least the image and the gesture and providing the query to a search engine. The method also provides receiving a response to the query and outputting the response.

### CROSS-REFERENCE TO RELATED APPLICATION

This application claims priority to U.S. Provisional Patent Application No. 63/563,936, filed Mar. 11, 2024, entitled “SEARCHING USING A WEARABLE COMPUTING DEVICE,” the disclosures of which are incorporated herein by reference in their entirety.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices include headsets, glasses, or screens equipped with sensors, cameras, and displays that track the movement of users and their surroundings to deliver immersive experiences across various applications such as gaming, education, healthcare, on-the-go computing, and industrial training.

### SUMMARY

This disclosure relates to systems and methods for causing a search, e.g., on a wearable device. In at least one implementation, a wearable device can be configured to capture images. In some implementations, the wearable device can be configured to determine when an image includes a gesture. The gesture can include a pointing gesture, a snapping gesture, or another gesture. In response to detecting the gesture in the image, the wearable device can be configured to generate a query from the image and the gesture. In some examples, the query can be determined, at least partially, from voice input received in conjunction with the gesture. Once generated, the wearable device can be configured to provide the query to a search engine, receive a response to the query, and output the response. In some implementations, the response can be provided via a display on the wearable device. In some implementations, the response can be provided via a speaker of the wearable device. In some implementations, the user can provide voice input for an additional query based on the response.

In some aspects, the techniques described herein relate to a method including: capturing an image; determining the image includes a gesture; and in response to determining the image includes the gesture: generating a query from at least the image and the gesture, providing the query to a search engine, receiving a response to the query, and outputting the response.

In some aspects, the techniques described herein relate to a computing system including: a computer-readable storage media; at least one processor operatively coupled to the computer-readable storage media; and program instructions stored on the computer-readable storage media that, when executed by the at least one processor, direct the at least one processor to perform a method, the method including: capturing an image; determining the image includes a gesture; and in response to determining the image includes the gesture: generating a query from at least the image and the gesture, providing the query to a search engine, receiving a response to the query, and outputting the response.

In some aspects, the techniques described herein relate to a computer-readable storage medium having program instructions stored thereon that, when executed by at least one processor, direct the at least one processor to perform a method, the method including: capturing an image; determining the image includes a gesture; and in response to determining the image includes the gesture: generating a query from at least the image and the gesture, providing the query to a search engine, receiving a response to the query, and outputting the response.

The details of one or more implementations are outlined in the accompanying drawings and the description below. Other features will be apparent from the description and drawings and the claims.

### BRIEF DESCRIPTION OF THE DRAWINGS

FIG. 1 illustrates a computing environment to manage searches for a wearable device according to an implementation.

FIG. 2 illustrates a method of operating a wearable device to provide a search according to an implementation.

FIG. 3 illustrates an operational scenario of generating a response to a gesture-caused query according to an implementation.

FIG. 4 illustrates an example user interface for responding to gesture-caused queries according to an implementation.

FIG. 5 illustrates a computing system to provide queries based on gestures according to an implementation.

### DETAILED DESCRIPTION

Computing devices, such as wearable devices and extended reality (XR) devices, provide users an effective tool for gaming, training, education, healthcare, mobile computing, and more. An XR device merges the physical and virtual worlds, encompassing virtual reality (VR), augmented reality (AR), and mixed reality (MR) experiences. These devices can include headsets or glasses equipped with sensors, cameras, and displays that track users' movements and surroundings, allowing them to interact with digital content. XR devices offer immersive experiences by either completely replacing the real world with a virtual one (VR), overlaying digital information onto the real world (AR), or seamlessly integrating digital and physical elements (MR). Input to XR devices may be provided through gestures, voice commands, controllers, and eye movements. Users interact with the virtual environment by manipulating objects, navigating menus, and triggering actions using these input methods, which are translated by the device's sensors and algorithms into corresponding digital interactions within the XR space. Additionally, the user can initiate searches using a voice command or selecting a physical or virtual button. However, at least one technical problem exists in efficiently permitting users to naturally generate queries associated with objects in the user's view.

In at least one technical solution, a wearable device can be configured to receive images from a camera on the device. In some implementations, the camera can be located on a front-facing portion of the device to identify gestures, the physical environment, and spatial awareness. In some examples, the camera can represent a red, green, and blue (RGB) camera outwardly oriented to capture user-generated gestures. In some implementations, the camera can comprise a depth camera, such as Time-of-Flight (ToF) camera or a structured light sensor. In some implementations, the camera can represent an infrared camera. The cameras can be configured to capture at least a portion of the environment and potential user-generated gestures.

In some implementations, the wearable device can be configured to identify a gesture in an image. A gesture can be a hand or finger movement recognized by the device's cameras, sensors, and processing system. In some examples, the gesture corresponds to a body portion of the user (e.g., finger, hand, or arm). In some examples, the gesture comprises a pointing gesture using a hand or finger. The device can receive a set of images and determine when an image includes the defined gesture. In response to identifying the gesture, the wearable device can be configured to generate a query from the image and the gesture. In some implementations, the wearable device can generate a text query corresponding to the intent. For example, based on pointing at the object, the wearable device can create a query prompt for the object being referenced (e.g., “what is this [object pictured].” The query can include the text prompt and at least a portion of the image captured by the camera. In some implementations, the text can provide context for identifying the object of interest in the image (i.e., the object associated with the gesture). In some implementations, the query can include a portion of the image with objects referenced by the gesture (physical or virtual). In some implementations, the query can be generated from voice input provided in response to the user's gesture. The voice input can indicate the information the user wants as a response for the referenced object. For example, after a user provides a gesture that points at an object, the user can provide a voice input “how much does this cost?” The voice input can be used to generate a query that returns the information desired by the user.

After generating the query, the wearable device can be configured to communicate or provide the query to a search engine and receive a response to the query. In some implementations, a search engine is a computer-implemented system that retrieves, indexes, and ranks digital content from distributed network resources based on queries using automated data acquisition, structured indexing, and relevance-based ranking algorithms. In some implementations, the search engine can respond with direct answers, such as a word or text indicating information associated with the referenced object (e.g., the name of the object and attributes related to the object). In some implementations, the search engine can provide summarized content from web pages or search results related to the object referenced by the user. In some implementations, the response can include web links. In some implementations, the response can consist of videos or supplemental images. In some implementations, the system can generate a response using a language model that uses a trained dataset, web searches, and/or context from the query. In some implementations, the response can include any combination of the abovementioned results.

When the result is received, the wearable device can provide the result to the user. In some implementations, the wearable device can display the result. In some implementations, the wearable device can provide an audio version of the response using one or more speakers on the device. In some examples, the user can generate a second request after the result is provided. The second request can include context (e.g., naming, attributes, and the like) from the provided response. As at least one technical effect, a system can provide the user with a search result without a verbal command or button press (physical or virtual). This can permit a user to more effectively and efficiently initiate a search without disturbing other individuals in the user's proximity.

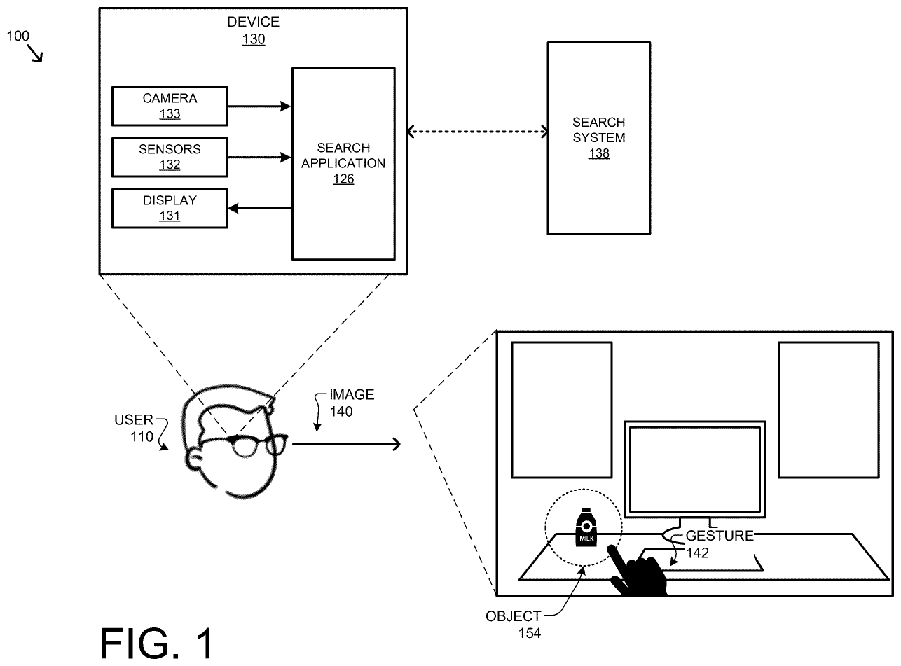

FIG. 1 illustrates a computing environment 100 to manage searches for a wearable device according to an implementation. Computing environment 100 includes user 110, device 130, search system 138, and image 140. Device 130 includes display 131, sensors 132, camera 133, and search application 126. Image 140 represents an image captured by device 130 and includes gesture 142 and object 154. Device 130 is an example of a wearable device, such as an XR device, smart glasses, or another wearable device. Search system 138 can include one or more desktop computers, server computers, tablets, smartphones, or other systems that can provide the search engine operations described herein.

In computing environment 100, device 130 includes display 131, which is a screen or projection surface that presents immersive visual content to user 110, merging virtual elements with the real world. Display 131 can include optical see-through displays (e.g., AR headsets) or video pass-through (e.g., MR/VR devices). Device 130 further includes sensors 132, such as accelerometers, gyroscopes, magnetometers, depth, infrared, and proximity sensors. The sensors can be used to monitor the physical movement of the user, identify depth information for other objects, identify eye movement for the user, or provide some other operation. Device 130 also includes camera 133, which can capture the real or physical environment to overlay virtual objects (e.g., application interfaces) for identifying movements of user 110 and surroundings to enable accurate interaction within the augmented or virtual space. In some examples, camera 133 can be positioned as an outward view to capture the physical world associated with the user's gaze. Display 131 can receive updates from search application 126 to overlay a search result from search system 138. Sensors 132 and camera 133 provide data to search application 126 that can be used to identify gestures from user 110 and initiate searches associated with the gestures.

In the example of computing environment 100, device 130 captures image 140, which includes at least a portion of the physical environment for user 110. When the image is captured, search application 126 can be configured to preprocess the image in some examples to improve the quality associated with the image. In some implementations, search application 126 can be configured to detect key features like hand shapes or finger positions using computer vision techniques. A machine learning model, such as a convolutional Neural Network (CNN), can classify the gesture by detecting patterns, such as edges, textures, and shapes, enabling gesture classification. In some implementations, the machine learning model can be configured (or trained) using a training set associated with a particular gesture (e.g., user pointing or using an index finger to reference an object). The model can operate as part of search application 126 in some examples. In some implementations, the model can receive a stream of images or video from at least one camera and process the images to capture a gesture configured as part of a machine-learning process. In some implementations, the gesture comprises a hand and/or finger pointing gesture. The gesture can comprise other gestures in some examples.

When a gesture is identified, search application 126 can be configured to generate a query from the image and the gesture and provide the query to search system 138. In some implementations, the query includes at least a portion of the image. In some implementations, the query includes the entire image. In other implementations, a portion of the image, including an object referenced by the user, is provided as part of the query. For example, search application 126 can be configured to separate the left portion of image 140 from the right side of the image. Once separated, the left portion can be provided as part of the query. In some implementations, search application 126 can identify the gesture and identify a segment or portion of the image associated with the query. Search application 126 can identify individual objects (e.g., an apple) or can identify a portion of the image most near the gesture (e.g., pixels nearest the gesture). In some examples, the query can include text or a text prompt for identifying information associated with the object (e.g., what is the user pointing to in the included image). In some examples, the text portion of the query can be indifferent to the object being referenced. In some examples, instead of a physical object, such as object 154, the user can gesture toward a virtual object or object displayed by device 130. Device 130 can be configured to determine the intersection of the user's gesture (e.g., pointing gesture) and gaze to identify the physical or virtual object referenced by the user. In some examples, when no virtual object is available, device 130 can be configured to determine the user is referencing a physical object. In some examples, the text prompt can be derived from the voice of user 110. However, if voice is unavailable or the user does not provide a prompt, device 130 can use a default prompt associated with the image (e.g., what is this?).

When the query is generated and provided to search system 138, search system 138 generates a response and returns the response to device 130. In some implementations, the response is generated using a language model. A language model processes a query with an image and text by first analyzing the text (i.e., text prompt) using natural language processing (NLP) and the image using computer vision techniques like convolutional neural networks (CNNs) or vision transformers (ViTs). It extracts features from both modalities, aligns them for contextual understanding, and then generates a response by integrating relevant information. In some implementations, search system 138 can use a trained dataset, web searches, and context from the provided text and image to generate the response.

In some implementations, the response is displayed via display 131. In some implementations, the response is provided via at least one speaker on device 130. In at least one example, user 110 can provide an additional gesture associated with a different object and search system 138 can provide an additional response. In at least one example, user 110 can provide additional prompts (e.g., voice prompts) to obtain additional information associated with the originally referenced object with the gesture.

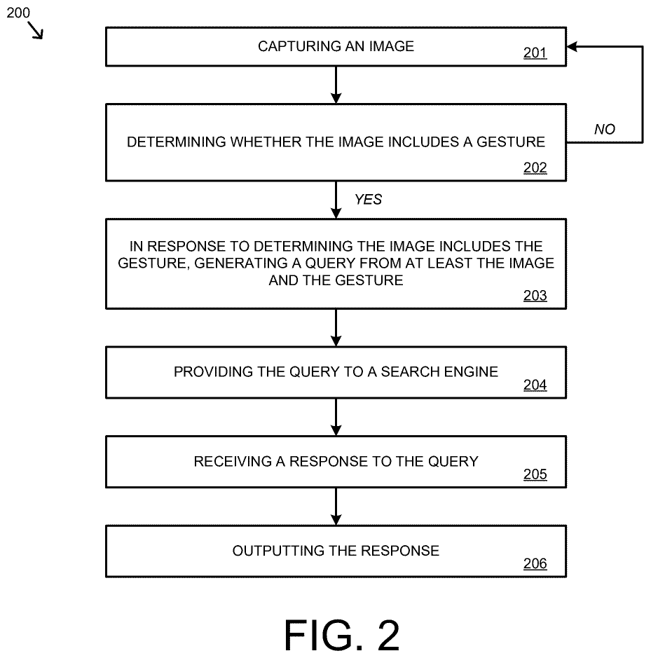

FIG. 2 illustrates method 200 of operating a wearable device to provide a search according to an implementation. The operations of method 200 are described below with reference to systems and elements of computing environment 100 of FIG. 1.

As shown in FIG. 2, in step 201, a field of view of a camera of the wearable device is analyzed. The field of view may represent an image captured by the camera. For example, the image may be analyzed for a search gesture. The search gesture is a predetermined gesture of a body part. The predetermined gesture can be a pointing gesture. A pointing gesture can be a hand with one finger extended. The detection of the search gesture can indicate that a user has shown an intent to begin a search of the image in the field of view.

In step 202 the system determines whether the search gesture is found. If a search gesture is not identified in the image (202 No), the system continues to monitor and analyze the field of view. Thus, steps 201 to 202 may be an “always on” process that enables a user to initiate a search without having to touch any part of the wearable device or another user computing device. The user can also not be required to provide voice input to trigger the search.

If in step 202 a search gesture is detected (202 Yes), the system may start (initiate, invoke) a search application at step 203. The search application may run on a wearable device, such as search application 126. The search application may be running on a companion user device in some examples (e.g., smartphone, tablet, and the like communicatively coupled to the wearable device). The search application may generate a query from at least one image captured by the device and the gesture at step 203. In some implementations, the user can provide a prompt once the gesture is identified. In some implementations, the prompt may be an utterance captured by a microphone and converted from speech to text. In some implementations, the search application may wait a predetermined period (i.e., timeout period) for the prompt. If no prompt is provided (i.e., expiration of the timeout period), some implementations may use a default prompt as part of the generated query. For example, a default prompt can include “What is this [referenced object],” while a prompt from the user can provide “How many calories are in this [referenced object].”

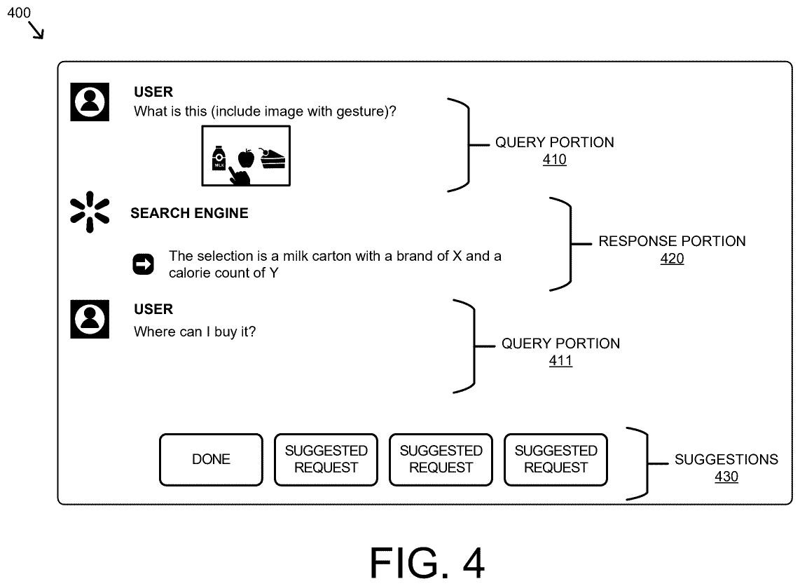

In some implementations, the query includes the image with the search gesture. The query can include the prompt if provided by the user or a default prompt if not provided by the user. The query can also include a search gesture description. If a prompt is received from the user, the search gesture description may be text describing the search gesture. For example, a pointing search gesture may have “that the finger is pointing to” as the search gesture description. Thus, the query may be the image and the user prompt with the text “that the finger is pointing to” appended. The query is provided to a search engine at step 204. The search engine may include a language model. The language model may be trained to respond to a query provided. The query can include text. The query can include text and an image. The search engine can be remote from the wearable device (e.g., in a cloud computing system). The search engine can be included in a server system. At step 205, the system receives the response to the query and outputs the response to the user at step 206. Outputting the response can include displaying the response, as illustrated in FIG. 4. Outputting the response can include playing the response, e.g., converting a text response to an audio file played for the user. In some implementations, the user can provide additional prompts about the object referenced by the gesture or reference a new object. For example, the search application may continue to receive prompts and/or new images that include the search gesture and may repeat the steps of generating queries for the search engine.

Referring to an example from computing environment 100 of FIG. 1, device 130 captures image 140. From image 140, search application 126 identifies gesture 142 in association with object 154. In response to identifying gesture 142, search application 126 generates a query based on image 140 and gesture 142. In some implementations, user 110 further provides voice input corresponding to a prompt associated with the gesture. In some implementations, user 110 does not provide voice input, and search application 126 selects a default prompt associated with the query. Once the query is generated, which may include at least a portion of the image and the prompt, the query is provided to search system 138. Search system 138 generates a response and provides the response to device 130, permitting search application 126 to provide the response to user 110. In some implementations, the response is provided via a speaker at device 130. In some implementations, the response is provided via display 131. In at least one example, user 110 can provide additional gestures that are detected via camera 133 or can provide additional prompts associated with object 154.

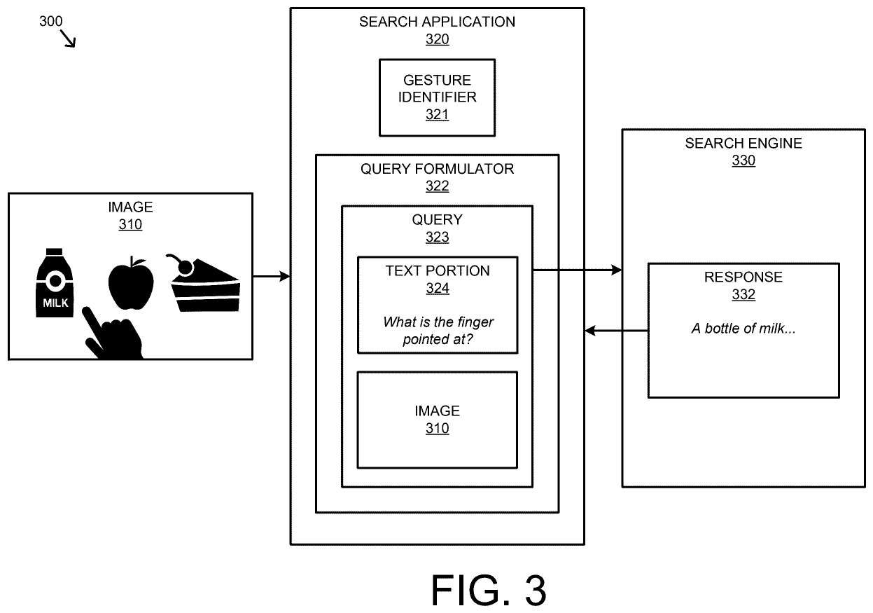

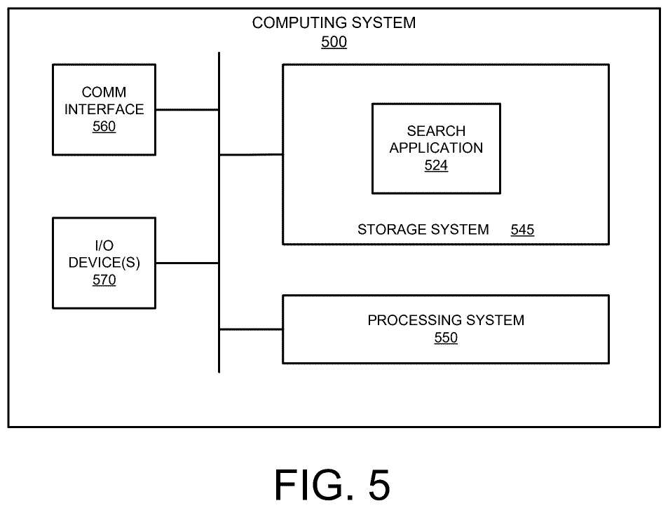

FIG. 3 illustrates an operational scenario 300 of generating a response to a gesture-caused query according to an implementation. Operational scenario 300 includes image 310, search application 320, and search engine 330. Search application 320 can be implemented on a computing device, such as device 130 of FIG. 1 or computing system 500 of FIG. 5. Search application 320 includes gesture identifier 321, query formulator 322, query 323, text portion 324 (e.g., prompt), and image 310. Search engine 330 generates response 332.

In operational scenario 300, gesture identifier 321 identifies a gesture in image 310. In some implementations, a device can include an outward-facing camera to capture one or more images and process one or more images using the search application 320. In some examples, gesture identifier 321 can include a model that identifies a pointing gesture, wherein the pointing gesture can be a hand or finger movement directed toward an object, location, or person to indicate, emphasize, or draw attention to the referenced object. In some implementations, the model represents a machine learning model that identifies the gesture in an image by using computer vision techniques, such as convolutional neural networks (CNNs), to detect hand and finger positions. By analyzing key points from pose estimation models, the model can recognize the extended index finger and the direction it is pointing relative to the rest of the body and surroundings. In some examples, the model is configured to identify a specific gesture and is configured from known examples of the gesture.

When the gesture is identified, query formulator 322 generates query 323. Query 323 includes a text portion 324 for the prompt and image 310 (or a portion of image 310). In some implementations, text portion 324 corresponds to a voice input provided by the user of the device. For example, in response to identifying the gesture in image 310, search application 320 can determine whether the user provides a prompt associated with the gesture. In some implementations, the prompt may be an utterance captured by a microphone and converted from speech to text. In some implementations, the search application may wait a predetermined period for the prompt. If no prompt is provided, some implementations may use a default prompt as part of the generated query. For example, the default prompt can be a predetermined text, e.g., “What is the finger pointed at?” In contrast, if the user provides a prompt, the prompt can be more specific in association with the object. When query 323 is generated with text portion 324 and image 310 (or a part thereof), query 323 is provided to search engine 330. The text portion may comprise the provided prompt or default prompt.

In some implementations, search engine 330 can include a language model that provides text as part of response 332. In some examples, a language model processes a query with both text and an image using a multimodal architecture, which integrates both input types. It first analyzes the text using natural language processing (NLP) and the image using computer vision techniques like CNNs or vision transformers (ViTs). Then, it combines insights from both modalities, aligning the extracted features to generate a coherent response. The final output is formulated based on contextual understanding, ensuring that the response is relevant to both the text and the visual information. In some implementations, the model can generate response 332 using knowledge from a trained dataset, web searches, and/or context from the provided text and image. For example, when query 323 is received, search engine 330 can process the image and the language to identify the object referenced in the gesture. Once response 332 is generated, search engine 330 can communicate response 332 to search application 320.

In some implementations, when response 332 is received, response 332 can be displayed via a display on the device. In some implementations, when response 332 is received, the device can convert response 332 (if required) to voice and provide the response via a speaker on the device. In some examples, once provided, the user of the device can generate additional prompts associated with the same object (e.g., “How many calories are in the bottle of milk”) or can reference a new object using a second gesture. For example, the user can transition to gesturing toward another object and a second query can be generated in association with the second object. In at least one example, the user can provide a first instance of the gesture toward a first object and receive a first search response. Then, use a second instance of the gesture toward a second object to receive a second search response.

FIG. 4 illustrates an example user interface 400 for responding to gesture-caused queries according to an implementation. User interface 400 includes query portion 410, response portion 420, query portion 411, and suggestions 430. User interface 400 can be provided by a computing device, such as device 130 of FIG. 1 or computing system 500 of FIG. 5.

In user interface 400, query portion 410 represents a query generated in response to a gesture identified via at least one image from a wearable device. The query includes a prompt (or text portion) and an image in some implementations. In some examples, the prompt is provided by the user in response to giving the gesture. In some examples, the prompt is autogenerated by the device based on the gesture provided by the user (e.g., “What is this?”). Once query portion 410 is generated, the query is communicated to a search engine that generates response portion 420. The user can then provide additional query portion 411, where additional query portion 411 can relate to the original image or can correspond to a second gesture provided by the user. For example, while the user provides a first instance of a gesture associated with a first object, the user can provide an additional instance of the gesture detected by the camera.

In some implementations, the search engine can further provide suggestions 430 correspond to suggested queries associated with an object. The queries can be generated based on the object type in some examples. For example, a first object type (e.g., food) can be associated with a first set of suggestions for future prompts, while a second object type (e.g., electronics) can be associated with a second set of prompts. The user can select a potential prompt from suggestions 430 to request additional information about the object referenced by the gesture.

FIG. 5 illustrates a computing system 500 to provide queries based on gestures according to an implementation. Computing system 500 represents any apparatus, computing system, or systems with which the various operational architectures, processes, scenarios, and sequences are disclosed herein for providing queries based on gestures can be implemented. Computing system 500 can be an example of an XR device, wearable device, or other computing device capable of the operations described herein. Computing system 500 is an example of device 130 from FIG. 1. Computing system 500 includes storage system 545, processing system 550, communication interface 560, and input/output (I/O) device(s) 570. Processing system 550 is operatively linked to communication interface 560, I/O device(s) 570, and storage system 545. In some implementations, communication interface 560 and/or I/O device(s) 570 may be communicatively linked to storage system 545. Computing system 500 may further include other components such as a battery and enclosure that are not shown for clarity.

Communication interface 560 comprises components that communicate over communication links, such as network cards, ports, radio frequency, processing circuitry (and corresponding software), or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format-including combinations thereof. Communication interface 560 may be configured to communicate with external devices, such as servers, user devices, or other computing devices.

I/O device(s) 570 may include peripherals of a computer that facilitate the interaction between the user and computing system 500. Examples of I/O device(s) 570 may include keyboards, mice, trackpads, monitors, displays, printers, cameras, microphones, external storage devices, sensors, and the like. In some implementations, I/O device(s) 570 include at least one outward-facing camera configured to capture images associated with the physical environment. In some implementations, I/O device(s) 570 consists of a see-through or video pass-through display providing a view of the physical environment. In some examples, the display can give or show responses to user queries. In some implementations, the computing system 500 can include at least one camera that captures an image, the image including a user gesture.

Processing system 550 comprises microprocessor circuitry (e.g., at least one processor) and other circuitry that retrieves and executes operating software (i.e., program instructions) from storage system 545. Storage system 545 may include volatile and nonvolatile, removable, and non-removable media implemented in any method or technology for storage of information, such as computer-readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media (also referred to as computer-readable storage media or a computer-readable storage medium) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises search application 524. The operating software on storage system 545 may further include an operating system, utilities, drivers, network interfaces, applications, or some other type of software. When read and executed by processing system 550 the operating software on storage system 545 directs computing system 500 to operate as described herein. In at least one implementation, the operating software can provide method 200 described in FIG. 2. The operating software can provide or cause the at least one processor to manage actions with physical objects as described herein.

In at least one implementation, search application 524 directs processing system 550 to capture an image and determine whether the image includes a gesture. The search application 524 further directs processing system 550 to generate a query from at least the image and the gesture in response to determining that the image includes the gesture. In some implementations, the query consists of a voice prompt provided by the user. In some implementations, the query includes a default prompt associated with the gesture. In some implementations, the default prompt is used when the voice prompt is not provided within a threshold period. Search application 524 further directs processing system 550 to provide the query to a search engine, receive a response to the query, and output the response. In some implementations, the response is output via a display. In some implementations, the response is output via a speaker. In some implementations, the output is provided via a combination of speaker and display.

Example clauses are provided below. Although these are examples, these clauses should not be considered exhaustive.

Clause 1. A method comprising: capturing an image; determining the image includes a gesture; and in response to determining the image includes the gesture: generating a query from at least the image and the gesture, providing the query to a search engine, receiving a response to the query, and outputting the response.

Clause 2. The method of clause 1, further comprising, in response to determining the image includes the gesture: receiving a voice prompt, wherein the query is further generated from the voice prompt.

Clause 3. The method of clause 1 or 2, wherein outputting the response comprises displaying the response on a display and the method further comprises: receiving a voice prompt associated with the response; generating a second query based on the voice prompt; and providing the second query to the search engine.

Clause 4. The method of any of clauses 1 to 3, further comprising: in response to determining the image includes the gesture, determining an expiration of a timeout period associated with a voice input from a user; and identifying a default prompt, wherein the query is further generated from the default prompt.

Clause 5. The method of any of clauses 1 to 4, wherein the query comprises at least a prompt and the image.

Clause 6. The method of any of clauses 1 to 5, wherein the image includes a first instance of a gesture, and the method further comprising: capturing a second image; determining that the second image includes a second instance of the gesture; and in response to determining the second image includes a second instance of the gesture; generating a second query from at least the second image and the gesture, providing the second query to the search engine, receiving a second response to the second query, and outputting the second response.

Clause 7. The method of any of clauses 1 to 6, wherein the gesture comprises a pointing gesture from a body portion of a user.

Clause 8. The method of any of clauses 1 to 7, wherein generating the query from at least the image and the gesture includes: identifying a portion of the image referenced by the gesture, wherein the query includes the portion of the image.

Clause 9. A computing system comprising: a computer-readable storage media; at least one processor operatively coupled to the computer-readable storage media; and program instructions stored on the computer-readable storage media that, when executed by the at least one processor, direct the at least one processor to perform a method, the method comprising: capturing an image; determining the image includes a gesture; and in response to determining the image includes the gesture: generating a query from at least the image and the gesture, providing the query to a search engine, receiving a response to the query, and outputting the response.

Clause 10. The computing system of clause 9, wherein the method further comprises: in response to determining the image includes the gesture, receiving a voice prompt, wherein the query is further generated from the voice prompt.

Clause 11. The computing system of clause 9 or 10, wherein outputting the response comprises displaying the response on a display and the method further comprises: receiving a voice prompt associated with the response; generating a second query based on the voice prompt; and providing the second query to the search engine.

Clause 12. The computing system of any clauses 9 to 11, wherein the method further comprises: in response to determining the image includes the gesture, determining an expiration of a timeout period associated with a voice input from a user; and identifying a default prompt, wherein the query is further generated from the default prompt.

Clause 13. The computing system of any of clauses 9 to 12, wherein the query comprises at least a prompt and the image.

Clause 14. The computing system of any of clauses 9 to 13, wherein the image includes a first instance of a gesture, and the method further comprising: capturing a second image; determining that the second image includes a second instance of the gesture; and in response to determining the second image includes a second instance of the gesture; generating a second query from at least the second image and the gesture, providing the second query to the search engine, receiving a second response to the second query, and outputting the second response.

Clause 15. The computing system of any of clauses 9 to 14, wherein the gesture comprises a pointing gesture from a body portion of a user.

Clause 16. The computing system of any of clauses 9 to 15, wherein generating the query from at least the image and the gesture includes: identifying a portion of the image referenced by the gesture, wherein the query includes the portion of the image.

Clause 17. A computer-readable storage medium having program instructions stored thereon that, when executed by at least one processor, direct the at least one processor to perform a method, the method comprising: capturing an image; determining the image includes a gesture; and in response to determining the image includes the gesture: generating a query from at least the image and the gesture, providing the query to a search engine, receiving a response to the query, and outputting the response.

Clause 18. The computer-readable storage medium of clause 17, wherein the method further comprises: in response to determining the image includes the gesture, receiving a voice prompt, wherein the query is further generated from the voice prompt.

Clause 19. The computer-readable storage medium of clause 17 or 18, wherein the method further comprises: in response to determining the image includes the gesture, determining an expiration of a timeout period associated with a voice input from a user; and identifying a default prompt, wherein the query is further generated from the default prompt.

Clause 20. The computer-readable storage medium of any of clauses 17 to 19, wherein the gesture comprises a pointing gesture from a body portion of a user.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used concerning a currently considered or illustrated orientation. If they are considered concerning another orientation, such terms must be correspondingly modified.

Further, in this specification and the appended claims, the singular forms “a,” “an” and “the” do not exclude the plural reference unless the context dictates otherwise. Moreover, conjunctions such as “and,” “or,” and “and/or” are inclusive unless the context dictates otherwise. For example, “A and/or B” includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

What is claimed is:

1. A method comprising:
capturing an image;
determining the image includes a gesture; and
in response to determining the image includes the gesture:
generating a query from at least the image and the gesture,
providing the query to a search engine,
receiving a response to the query, and
outputting the response.

2. The method of claim 1, further comprising, in response to determining the image includes the gesture:
receiving a voice prompt,
wherein the query is further generated from the voice prompt.

3. The method of claim 1, wherein outputting the response comprises displaying the response on a display and the method further comprising:
receiving a voice prompt associated with the response;
generating a second query based on the voice prompt; and
providing the second query to the search engine.

4. The method of claim 1, further comprising:
in response to determining the image includes the gesture, determining an expiration of a timeout period associated with a voice input from a user; and
identifying a default prompt,
wherein the query is further generated from the default prompt.

5. The method of claim 1, wherein the query comprises at least a prompt and the image.

6. The method of claim 1, wherein the image includes a first instance of a gesture, and the method further comprising:
capturing a second image;
determining that the second image includes a second instance of the gesture; and
in response to determining the second image includes a second instance of the gesture;
generating a second query from at least the second image and the gesture,
providing the second query to the search engine,
receiving a second response to the second query, and
outputting the second response.

7. The method of claim 1, wherein the gesture comprises a pointing gesture from a body portion of a user.

8. The method of claim 1, wherein generating the query from at least the image and the gesture includes:
identifying a portion of the image referenced by the gesture,
wherein the query includes the portion of the image.

9. A computing system comprising:
a computer-readable storage media;
at least one processor operatively coupled to the computer-readable storage media; and
program instructions stored on the computer-readable storage media that, when executed by the at least one processor, direct the at least one processor to perform a method, the method comprising:
capturing an image;
determining the image includes a gesture; and
in response to determining the image includes the gesture:
generating a query from at least the image and the gesture,
providing the query to a search engine,
receiving a response to the query, and
outputting the response.

10. The computing system of claim 9, wherein the method further comprises:
in response to determining the image includes the gesture, receiving a voice prompt,
wherein the query is further generated from the voice prompt.

11. The computing system of claim 9, wherein outputting the response comprises displaying the response on a display and the method further comprises:
receiving a voice prompt associated with the response;
generating a second query based on the voice prompt; and
providing the second query to the search engine.

12. The computing system of claim 9, wherein the method further comprises:
in response to determining the image includes the gesture, determining an expiration of a timeout period associated with a voice input from a user; and
identifying a default prompt,
wherein the query is further generated from the default prompt.

13. The computing system of claim 9, wherein the query comprises at least a prompt and the image.

14. The computing system of claim 9, wherein the image includes a first instance of a gesture, and the method further comprising:
capturing a second image;
determining that the second image includes a second instance of the gesture; and
in response to determining the second image includes a second instance of the gesture;
generating a second query from at least the second image and the gesture,
providing the second query to the search engine,
receiving a second response to the second query, and
outputting the second response.

15. The computing system of claim 9, wherein the gesture comprises a pointing gesture from a body portion of a user.

16. The computing system of claim 9, wherein generating the query from at least the image and the gesture includes:
identifying a portion of the image referenced by the gesture,
wherein the query includes the portion of the image.

17. A computer-readable storage medium having program instructions stored thereon that, when executed by at least one processor, direct the at least one processor to perform a method, the method comprising:
capturing an image;
determining the image includes a gesture; and
in response to determining the image includes the gesture:
generating a query from at least the image and the gesture,
providing the query to a search engine,
receiving a response to the query, and
outputting the response.

18. The computer-readable storage medium of claim 17, wherein the method further comprises:
in response to determining the image includes the gesture, receiving a voice prompt,
wherein the query is further generated from the voice prompt.

19. The computer-readable storage medium of claim 17, wherein the method further comprises:
in response to determining the image includes the gesture, determining an expiration of a timeout period associated with a voice input from a user; and
identifying a default prompt,
wherein the query is further generated from the default prompt.

20. The computer-readable storage medium of claim 17, wherein the gesture comprises a pointing gesture from a body portion of a user.
